(19) United States
(12) Patent Application Publication
(10) Pub. No.: US 2009/0254472 A1
(43) Pub. Date: Oct. 8, 2009

(54) Cheapest unique bid

(76) Inventors: David Conboy, Albany, NY (US); Michael Olekosi, Troy, NY (US)

Correspondence Address: David Conboy, 70 Klink Road, Albany, NY, 12203, US

(21) Appl. No.: 12/080,835

(22) Filed: Apr. 7, 2008

(51) Int. Cl. G06Q 30/00

(52) U.S. Cl. 705/37

(57) ABSTRACT

The invention differs from traditional auction methodology, wherein the highest bidder is the successful bidder, to the lowest unique bidder is the successful bidder. The invention also differs from traditional and internet auctions, in that, no bidder is aware of any other bidder's bid(s). The invention differs from all other auction methodologies in that it compensates multiple lowest unique bidders as defined in claim number 3, who were not the successful bidder as defined in claim number 2.

Method and system of conducting an auction whereby the successful bidder of an auction is determined by being the lowest unique bidder in said auction. An auction of products or services is held whereby the bids placed for said products or services are blind bids where no bidder knows the bid of any other bidder. Each bidder is allowed to place one or multiple bids within any given auction. At the termination of each auction, the successful bidder shall be determined by the lowest unique bid within that auction. The following example, which contemplates the auctioning of a 10¢ (ten cent) product, is provided for illustrative purposes only.

| Price of Bid | Number of Bids Placed at the Respective Price |
|---|---|
| 1¢ | 2 |
| 2¢ | 2 |
| 3¢ | 2 |
| 4¢ | 2 |
| 5¢ | 2 |
| 6¢ | 2 |
| 7¢ | 1 |
| 8¢ | 2 |
| 9¢ | 2 |
| 10¢ | 2 |
| | 19 Total Bids |

7¢ is the lowest unique bid because there is only one bidder at that price. In this example, the person who bid 7¢ would be the successful bidder. If any auction has more than one bidder at the lowest unique bid, a random drawing is held inclusive of the lowest unique bidders and the bidder drawn from that random drawing shall become the successful bidder of that auction.

### CROSS-REFERENCE TO RELATED APPLICATIONS

U.S. Pat. No. 7,328,189

U.S. Pat. No. 7,249,027

U.S. Pat. No. 7,024,376

### BACKGROUND OF THE INVENTION

The use of the Internet and World Wide Web are becoming increasingly popular for commercial transactions. There are a number of ideas, including patented inventions, which are directed to the idea of buying and selling goods and services over the Internet. In particular, there are now a number of websites that facilitate Internet shopping.

In general, there are three methods for conducting commercial transactions over the Internet: auction-based, lowest price searching, and offers to purchase.

The first method, auction-based, generally comprises a website used to arbitrate bids and generate sales through competitive offers from multiple prospective purchasers. An example of an auction-based website may be found at www.auctions4acause.com.

The second method, lowest price searching, involves a method whereby the purchaser utilizes a website and a search engine to traverse multiple websites searching for the lowest price for the goods or services sought to be purchased.

The third method, offers to purchase, involves websites which accept offers from the prospective purchaser and either agree to sell the goods or services based on that price or rejects the offer, requesting a higher price from the purchaser. An example of this type of purchasing can be seen at www.priceline.com. Descriptions of search techniques and auction methods may be found in U.S. Pat. Nos. 5,897,620; 6,041,326; and 6,058,417.

There are a number of disadvantages for the purchaser who uses the methods of the current art. The auction-based method often results in a purchase predicated on a bid from the consumer where the bid is actually higher than sales prices posted on web sites offering direct (non-auction) purchase of the same item. Additionally, the auction-based methods generally offer goods and services from a single or limited number of sources, thus limiting the purchaser's supply options. Finally, the auction-based methods result in an upward spiral of the purchase price of an item during the bidding process, thus resulting in a transaction that favors the seller, not the purchaser.

The lowest price searching method discloses an arbitrary price posted by a vendor without any ability on the part of the purchaser to negotiate a lower price. Additionally, use of this method forecloses the possibility of obtaining a more favorable price through an auction process.

The offer to purchase method restricts the purchaser to one source of items, thus excluding sources that might accept a lower offer from the purchaser. Also, a purchaser using this method does not necessarily have knowledge of posted advertised prices from other sources, and thus submits an offer higher in price than the price advertised by the other sources.

What is needed therefore is an auction method and system for purchasing goods and services, that benefits the bidders by rewarding the bidder who has placed the lowest unique bid in the auction, thus giving the consumer the ability to purchase products and services at prices considerably below that of the normal and customary retail price.

Additionally, this methodology for conducting auctions collects fees from either bidders, advertisers or other sources, or any combination thereof, as a means to defray the expense of the products or services being auctioned.

### BRIEF SUMMARY OF THE INVENTION

The present invention overcomes the deficiencies noted in the current art, and provides a method and system whereby a bidder may purchase products and services for prices considerably below that of the normal and customary retail price. By employing a methodology whereby each bidder, advertiser, or other source, or any combination thereof, pays a fee that helps offset the cost of the products and services being auctioned, successful bidders are able to purchase products and services at prices considerably below what they would pay through other means currently available.

The present invention also employs a methodology and system that allows auctions to be held wherein the successful bidder is the bidder who has placed the lowest unique bid.

### DETAILED DESCRIPTION OF THE INVENTION

The invention employs a method and system of conducting an auction wherein the successful bidder of an auction is determined by being the lowest unique bidder in said auction. An auction of products or services is held whereby the bids placed for said products or services are blind bids where no bidder knows the bid of any other bidder. Each bidder is allowed to place one or multiple bids within any given auction. At the termination of each auction, the successful bidder shall be determined by the lowest unique bid within that auction. The following example, which contemplates the auctioning of a 10¢ (ten cent) product, is provided for illustrative purposes only.

| Price of Bid | Number of Bids Placed at the Respective Price |
|---|---|
| 1¢ | 2 |
| 2¢ | 2 |
| 3¢ | 2 |
| 4¢ | 2 |
| 5¢ | 2 |
| 6¢ | 2 |
| 7¢ | 1 |
| 8¢ | 2 |
| 9¢ | 2 |
| 10¢ | 2 |
| | 19 Total Bids |

7¢ is the lowest unique bid because there is only one bidder at that price. In this example, the person who bid 7¢ would be the successful bidder. If any auction has more than one bidder at the lowest unique bid, a random drawing is held inclusive of the lowest unique bidders and the bidder drawn from that random drawing shall become the successful bidder of that auction.

The invention differs from standard, non-internet, auctions in many ways. One way is that the invention processes bids electronically over the internet whereas standard, non-internet, auctions must be attended, in person, by the bidder. Due to geographical and travel limitations, standard, non-internet, auctions dramatically reduce the number of bidders that may place bids within any auction and they also reduce the consumer's/bidder's ability to become a participant in an auction that is not readily geographically accessible to the bidder/consumer.

Standard, non-internet, auctions traditionally have auctions whereby the products and/or services being auctioned, go to the highest bidder. The highest bidder is generally determined as the last bidder at the highest price, when no one bids higher than the last highest bid. The invention differs from standard, non-internet, auctions in that the successful bidder is the lowest unique bidder, as opposed to the highest bidder.

Standard, non-internet, auctions award the auctioned products or services to the highest bidder which makes the products or services being auctioned more expensive compared to the invention, which awards the auctioned products or services to the lowest unique bidder. The invention works to decrease the cost of the items being auctioned whereas traditional auctions attempt to increase the cost of the items being auctioned.

The successful bidder at a standard, non-internet, auction is solely responsible for the cost of removing the auctioned item from the auction site and delivering it to the bidder's location. The invention removes the responsibility of shipping and handling from the bidder and becomes the party responsible for delivering the auctioned item to the bidder's location. This portion of the invention helps further reduce any costs associated with being a successful bidder in an auction of the invention.

Current internet based auctions work in many ways that differ from that of the invention. In certain internet based auctions, the successful bidder is the highest unique bidder—determined much the same way as the invention determines the lowest unique bidder, except in the highest unique bidder auctions, it is the highest unique bid that is successful instead of the lowest unique bidder.

Current internet based auctions disclose information relative to the current price, or range of prices, that have been bid on the then current auction. This methodology works to the advantage of the current bidder and to the disadvantage of previous bidders. The invention does not disclose any prices, or range of prices, of any bids placed within any auction, thereby equalizing the opportunity for all bidders.

1. The invention claims to sell products and/or services, via a blind auction format, which does not disclose any other bidder's bid(s) to any other bidder, wherein the lowest unique bidder becomes the successful bidder.

2. The invention claims that, in the event that there is more than one unique lowest bidder, the successful bidder shall be the bidder who was the first person to place a bid at that price point.

3. The invention claims that, in the event of claim number 2, all unique lowest bidders who placed their bids at any time after the first person placed the bid at that price point, shall receive 5% (five-percent) of the retail value of the merchandise being auctioned, divided by the number of persons who bid at that lowest unique price point. As an example: if a gift card with a retail value of one-thousand dollars is being auctioned off and there are 5 lowest unique bidders, the person who placed the first bid at that price point would receive the one-thousand dollar gift card, and the 4 other bidders at that price would all receive five-percent of the retail value of the merchandise divided equally among the 4 unsuccessful lowest unique bidders. In this example, that would amount to $12.50 (twelve dollars fifty cents) each to the 4 unsuccessful lowest unique bidders in said auction.

4. The invention claims to allow bidders to obtain products and/or services well below the normal and customary retail price of said merchandise by collecting fees from either bidders, advertisers, or other sources, or any combination thereof, as a means to defray the expense of the products or services being auctioned.
